(19) United States
(12) Patent Application Publication
(10) Pub. No.: US 2004/0181559 A1
(43) Pub. Date: Sep. 16, 2004

(54) Method for registering and searching user's position information and system thereof

(76) Inventors: Sang-Zee Lee, Daejeon (KR); Dong-Hoon Park, Seoul (KR)

Correspondence Address: FROST BROWN TODD, LLC, 2200 PNC CENTER, 201 E. FIFTH STREET, CINCINNATI, OH, 45202, US

(21) Appl. No.: 10/485,493

(22) PCT Filed: Aug. 13, 2001
(86) PCT No.: PCT/KR01/01379

(51) Int. Cl. G06F 12/00

(52) U.S. Cl. 707/201

(57) ABSTRACT

A method and a system for registering and searching for user's location information stored at the distributed location information domain servers using user's position IDs are provided. The system includes a location information domain manager terminal, a location information domain manager terminal, a location information domain management server having a location information domain management database, a plurality of location information domain servers each of which has a location of information database storing the user's location information (coordinate), a plurality of general domain servers and a plurality of user terminals, which are connected through the Internet, to thereby register the user's location information (coordinate) at each location information domain server and, if required, search for the user's location information through the domain server with which a user terminal connects.

### TECHNICAL FIELD

The present invention relates to a method and a system for registering and searching for user's location information using the user's position ID which is registered and stored at the distributed location information domain server. Specifically, the invention relates to a method and a system for registering and searching for a location information using the user's position ID(so called ‘ePosition’), which can be registered by the user and stored at the distributed location information domain server. The location information related with the registered user's position ID includes a location information domain manager terminal, a location information domain management server having a location information domain management database, a plurality of location information domain servers each of which has a location information database storing the user's location information (coordinate), a plurality of general domain servers and a plurality of user terminals, which are connected through the wired or wireless internet, to thereby register the user's location information (coordinate) at each location information domain server and, if required, search any domain server with which a user terminal connects for the user's location information.

### BACKGROUND ART

Recently, the wired or wireless Internet has been widely being used and commercial transaction via the Internet has been activated. When a user (consumer) selects goods to purchase on the Internet, a site selling the goods delivers them to the user with the help of a delivery service company or a distribution center. The site selling goods should know information about the location of the user in order to deliver goods the user wants to buy to him. Thus, the site obtains the information about the address of the user through subscription or by malting an inquiry of the user.

In prior arts, the user registered his address including the name representing the location as subscriber registration information when the user signed in the shopping mall site. Otherwise, the user entered his address in the site when he purchased goods as a general consumer.

It is worthwhile to note that the address styles for some countries are different from the others and some of them are limited to identify a point location because of their characteristics representing an area instead of a point.

Furthermore, the location information database on the sites (domain servers) are independently constructed in their own data format and manners so that they may not share jointly the location database including the address of the user. Furthermore the name representing a location like firm, building, bank, hotel, hospital and others may not be unique, and is, therefore, limited to identify its location uniquely in the world.

In other case that the user can't use the conventional address or the name representing an arbitrary location as in the sea or on the mountain, there was no way to inform the point location simply and exactly.

As mentioned above, there was no unified and simple method of representing an arbitrary location on the earth uniquely by registering its location by the position ID or searching the location information and displaying its location on the map using the registered position ID. Accordingly, it is difficult or there is no way to identify the accurate point location only with the conventional address or the location name in an area poorly readjusted.

### DISCLOSURE OF INVENTION

An object of the present invention is to provide a system constructed in a manner that a location information domain manager terminal, a location information domain management server having a location information domain management database, a plurality of location information domain servers each of which has a location information domain database storing user's location information (coordinate), a plurality of general domain servers and a plurality of user terminals are connected through the wired or wireless Internet, by which the user's location information (coordinate) with a user's position ID(so called ePosition) can be registered at each of the location information domain servers and the registered location information can be shared through the Internet for some application of searching and displaying its location on the digital map, being used for car navigation and telematics and other purpose.

Another object of the present invention is to provide a method of registering a location information domain at the location information domain management server and registering the user's location information (coordinate) together with the position ID(ePosition) at the location information domain servers using the above-described system, by which a web server can search for the user's location information (coordinate) through the Internet using the position ID even when the user is connected to another web server (under the control of the management of the location information domain management server).

Still another object of the present invention is to register and store the user's location information in the plurality of the location information domain servers distributed in the world through the Internet.

Yet another object of the present invention is to allow a user terminal linked even to the general domain server (web server) that is not registered as a location information domain server at the location information domain management server to be able to search for the user's location information registered at other location information domain servers and managed by them.

To accomplish the objects of the present invention, there is provided a system for registering and searching for user's location information with the user's position ID stored in the distributed location information domain servers, comprising: a location information domain management server having a location information domain management database, the location information domain management server managing a plurality of location information domain servers, the location information domain management server carrying out an operation of registering, updating, modifying or deleting a location information domain and storing information related with the operation in the location information domain management database; the plurality of location information domain servers each of which has a location information domain database registering user's location information together with a position ID to store them in the location information domain databases and manage (update, modify or delete) them, each location information domain server searching for user's location information (coordinate) requested by another web server to transmit it to the requesting web server or requesting another location information domain server to search for the user's location information (coordinate); a location information domain manager terminal for managing the location information domain management server; user terminals by which users connect with desired web servers through the Internet; general domain servers each of which is not registered at the location information domain management server as one of the location information domain servers, each general domain server having software required for searching for the user's location information installed therein, each general domain server having no functions of storing and managing the user's location information; and the Internet, wherein the user's location information is registered together with the position ID at the information location domain servers and the registered user's location information is confirmed.

To accomplish the objects of the present invention, there is also provided a method for registering and searching for user's location information with user IDs using the distributed location information domain servers, the method comprising: a location information domain management server connection step in which a user who wants to register at a location information domain server or to search for location information connects with a location information domain management server; a location information domain registration confirming step for confirming if the same location information domain that someone wants to register was already registered previously; a location information domain registration step for registering the location information domain when it is confirmed that the same location information domain was not registered previously; a step in which the user registered at the location information domain server or the user who wants to search for location information can connect with the location information domain server; a step for confirming if the same position ID to be registered with a location information (coordinate) has not been registered previously; a user location information registration step for registering the position ID with its corresponding location information (coordinate) when the same position ID has not been registered previously at the location information domain server; a step in which the user carries out an operation he wants to do at a web server with which the user connects through the Internet; and a step for connecting with the location information domain server at which the location information has been registered to search for the point location information (coordinate) corresponding to a position ID.

### BRIEF DESCRIPTION OF THE DRAWINGS

Further objects and advantages of the invention can be more fully understood from the following detailed description taken in conjunction with the accompanying drawings, in which:

FIG. 1 roughly shows a system for registering and searching for the point location coordinate with its corresponding to a position ID stored at the distributed location information domain servers connected through the Internet in accordance with the present invention;

FIG. 2 is a flow diagram for showing a method of registering a point location information with its corresponding position ID and searching for the point location coordinate using the location information domain servers in accordance with the present invention;

FIG. 3 is a flow diagram for showing in detail the step of registering a location information domain at the location information domain management server among the steps of FIG. 2;

FIG. 4 shows an example of a registration form provided for registration of the location information domain at the step of presenting the registration form of FIG. 3;

FIG. 5 is a flow diagram for showing in detail the step of registering the location information at the location information domain servers among the steps of FIG. 2; and

FIG. 6 is a flow diagram for showing in detail the step of searching for the point location information (coordinate) using its corresponding position ID registered at a certain location information domain server among the steps of FIG. 2.

### BEST MODE FOR CARRYING OUT THE INVENTION

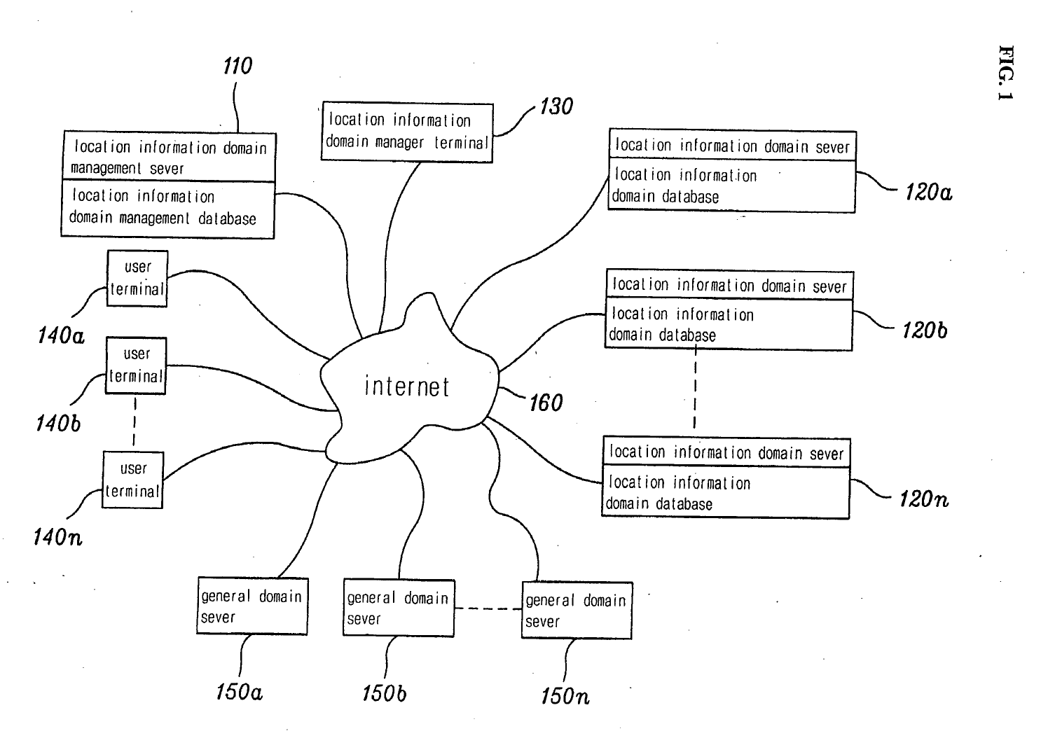

FIG. 1 roughly shows a system for performing a method of registering and searching for the point location coordinate using its corresponding position ID stored at the distributed location information domain servers in accordance with the present invention. Here, the location information does not mean information like the conventional address constructed of a city, a district, a block and a street number but a location coordinate including the longitude and latitude value based on a coordinate system and its position ID for identifying the location coordinate. Specifically, the TM coordinate or UTM coordinate based on the earth ellipsoid such as WGS-84 or Bessel are another examples of the location information (coordinate)

Accordingly, each user has his own user location information (coordinate) corresponding to the place like office, home and so on, and this location information is registered by its position ID in the form of [user ID]#[location information domain]. Thus, it is possible to search for a point location information (coordinate) using its registered position ID.

The user position ID mentioned above can be represented in a manner similar to the form of the conventional e-mail ID. For instance, when the user ID is “gildong” and the domain at which the user ID is registered is “chollian.net”, the e-mail address is “gildong@chollian.net” where the symbol @ plays a roll of the e-mail address identifier. Similarly, in case where the user ID is “gildong” and the domain at which the used ID is registered is “chollian.net”, the position ID can be represented in “gildong#chollian.net” where the symbol # plays a roll of the position ID identifier. Here, the position ID identifier is not limited to the symbol #, and it is intended to explain that the position ID is represented in the aforementioned manner.

The system of the present invention includes a location information domain management server 110 having a location information domain management database, a plurality of location information domain servers 120 each of which has a location information domain database, a location information domain manager terminal 130, user terminals 140 and general domain servers 150. These constituent elements are all connected through the Internet 160.

Specifically, the location information domain management server 110, which manages the plurality of location information domain servers 120a to 120n, registers, updates, modifies or deletes a location information domain and stores information related with these operations in the location information domain management server. The plurality of location information domain servers 120a to 120n, which manage the user's location information (coordinate) registered at each domain server, are operated as independent and separate web domains after being registered as the location information domain servers.

However, a new web page for providing functions of location information domain server can be added to a existing web server (not shown). Specifically, in case where the web server not only carries out its usual role but also serves as the location information domain server 120, the domain name of the existing web server is registered as the location information domain and software for carrying out the performance of the location information domain server is installed in the existing web server. In other words, the location information domain servers 120a to 120n can be operated by using the existing web server or by using a new separate one.

The location information domain server 120 registers the user's location information (coordinate) and manages (updates, modifies or deletes) it. In addition, it can search for user's location information (coordinate) requested by another web server and to transmit it to the requesting web server, or it can request to other location information domain server to search for the specific location information (coordinate) stored at that location information domain server.

The information managed by the location information domain servers 120a to 120n is stored in the location information domain databases, and searching of a location information (coordinate) is processed by the same sort of program provided to the location information domain server when the location information domain server was registered in the location information domain management server 110.

The location information domain manager terminal 130 controls the location information domain management database in the location information domain management server 110. Though the location information domain manager terminal 130 is connected to the location information domain management server 110 via the Internet 160 in this embodiment, it can be connected through a LAN.

Each user terminal 140 is a general terminal by which a user does a desired work (purchasing goods) through a web server (not shown), or registers or searches for location information through the location information domain server 120.

Each of the general domain servers 150 is a general web server that is not registered at the location information domain management server 110 and it is the existing Internet web server to which a user can have access for the purpose of purchasing goods. Though this general domain server 150 is not registered at the location information domain management server 110 and does not have the user's location information, it can request the location information domain server 120 for searching for the user's location information (coordinate) to get it. The program for requesting the location information domain server to search for the user's location information must be installed in the general domain server 150.

Although the aforementioned constituent elements constructing the system of the invention are connected through the Internet, they are not directly connected to each other and the connection is restricted in order to prevent leak of user's personal information. That is, the location information domain manager terminal 130 manages information about the location information domain servers 120a to 120n through the location information domain management server 110, and a user can have access to the location information domain servers 120a to 120n or the general domain server 150 having the program required for searching for the location information installed therein using the user terminal 140. However, the connection state between the constituent elements is not decided strictly but it can be modified into the most appropriate state under the operation condition of the system.

By using the above-described system according to the present invention, the user has access to a web server (the existing web server or a new web server constructed (registered) together with the location information domain server) he wants to perform a required work (purchasing goods, for example). The web server obtains the user's location information (coordinate) required for delivering goods to the user through the location information domain server 120. Then, the information about the goods ordered by the user together with the user's location information obtained through the location information domain server 120 shall be transmitted to a distribution center for proper delivery.

The present invention has been explained with an application of purchasing goods in this embodiment but the field in which the user's location information is used is not limited thereto. That is, the user can connect with the location information domain management server 110 or directly connect with the location information domain server 120 in order to obtain location information according to the field in which the user's location information is employed. Otherwise, the user can attain the location information through any other web server he wants to connect or the current web server.

The user's location information (coordinate) can be searched for through the following method using the above-described system of the present invention.

The principle of searching for the user's location information is as follows. A person, group or company operating the existing web domain server connects with the location information domain management server 110 to register his location information domain at the server 110, and the person or an individual belonging to the group or company connects with the location information domain server 120 at which the person or the individual wants to register the location information thereof and inputs the location information (coordinate) together with the position ID thereof.

The user's position ID constructed as above, instead of the location information (coordinate), can be transferred to other people (or other web servers) and the other people (or other web servers) can obtain the registered user's location information (coordinate) using the registered user's position ID.

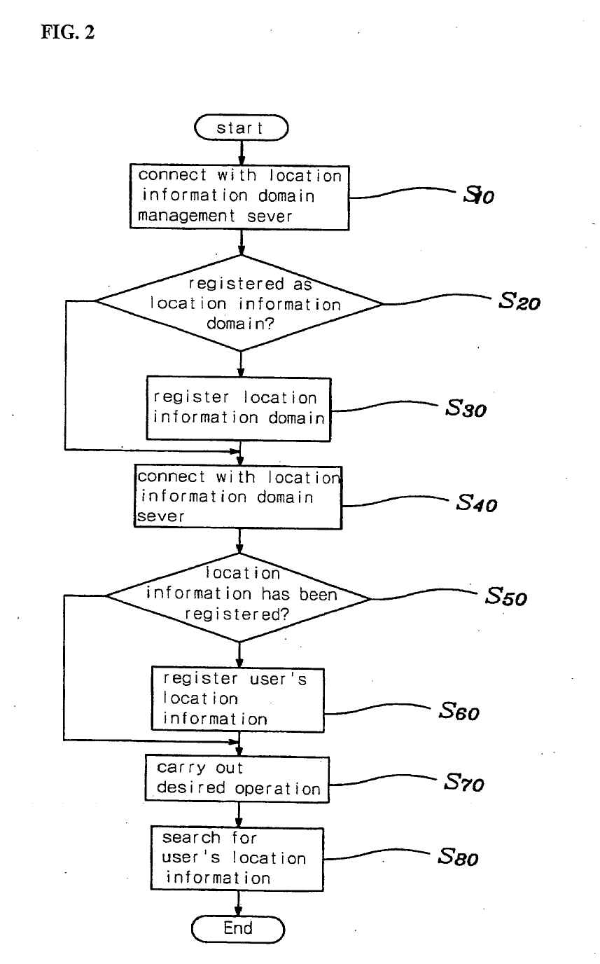

FIG. 2 is a flow diagram roughly showing a method for registering and searching for the user's location information (coordinate) using the distributed location information domain serves in accordance with the present invention. To search for the user's location information, the required location information must be registered through a step S30 of registering a location information domain and a step S60 of registering user's location information.

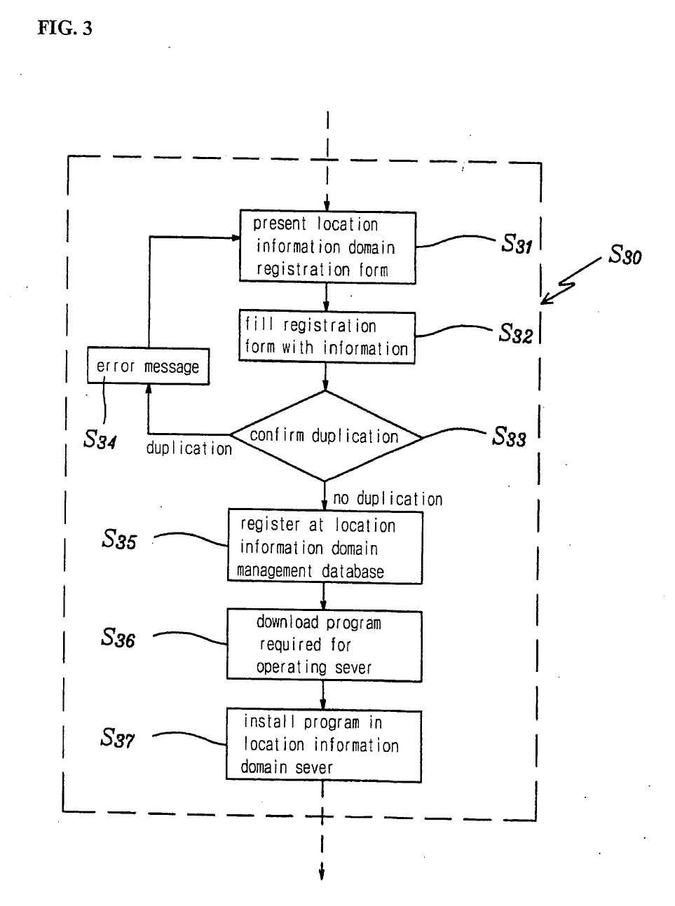

FIGS. 3, 5 and 6 are flow diagrams showing in detail the location information domain registration step S30, the user's location information registration step S60 and a user's location information searching step S80.

The present invention is explained with reference to the FIG. 2 to 6. First of all, a user who wants to register the location information domain server 120 or obtain location information connects with a location information domain management server 110 in a step S10. Then, it is confirmed if the location information domain server has been already registered as a location information domain in a location information domain registration confirming step S20. When it is confirmed that the same location information domain server has not been registered previously, the process goes to a location information domain registration step S30. On the other hand, when the same location information server has been already registered as a location information domain server 120 or it is not required to be registered (when the user connects with the location information domain management server only for searching for location information), the process goes to a step S40 at which the user connects with the location information domain server 120.

The location information domain registration step S30 is illustrated in detail in FIG. 3. When it is confirmed that the same location information domain server which the user want to register at the location information domain management server 110 has not been registered as a location information domain at the location information domain registration confirming step S20, the process goes to a step S31 where the location information domain management server 110 presents a form 170 for registration as a location information domain.

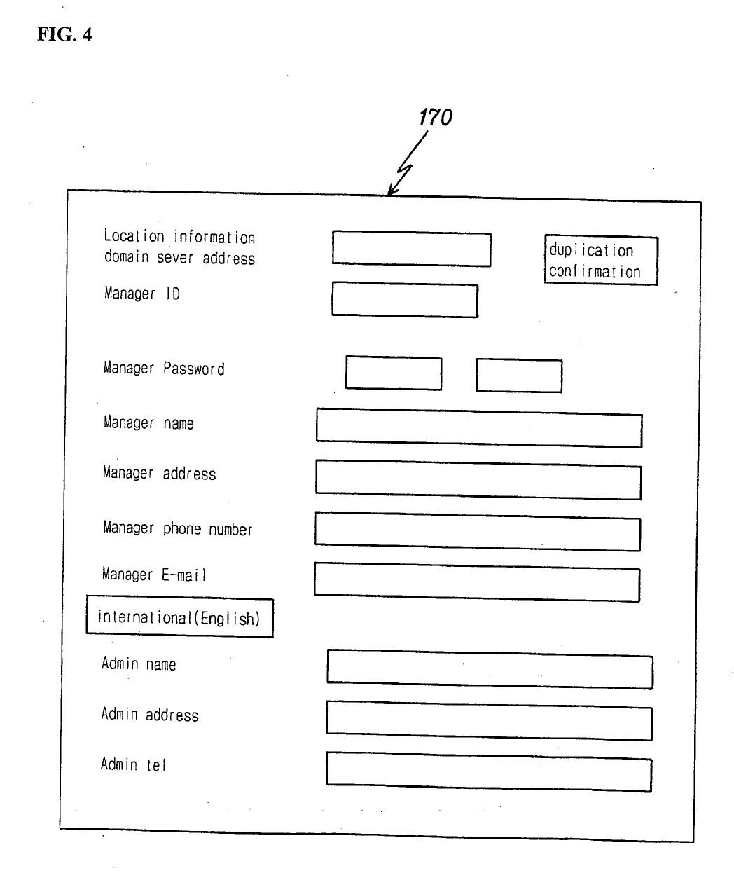

The registration form 170 as shown in FIG. 4 may be an example. The registration form 170 is filled with some information required for managing the registered location information domain server 120. The address of the domain server in the form 170 must be a unique address because it is an element constructing a part of the location information address for identifying a user uniquely as described below. Accordingly, after the information required is entered at the step S32, a duplication confirmation step S33 must be executed to confirm if the address of the location information domain server 120 to be registered is a unique address.

When it is confirmed that the address of the location information domain server 120 is not a unique one at the duplication confirmation step S33, the process goes to a step S34 of indicating an error message to inform the one who inputs the information into the form 170 that the same address as that of the location information domain server 120 to be registered already exists, and then goes back to the registration form presenting step S31 to allow the information required to be modified into the form 170.

When it is confirmed that the entered address is a unique one at the duplication confirmation step S33, the location information domain server 120 is registered at the location information domain management database and the information entered at the step S32 is recorded therein at a step S35. Then, the registered location information domain server 120 downloads program for its operation as a location information domain server from the location information domain management server 110. This step is the program download step S36.

The program downloaded from the location information domain management server 110, which is software required for operation of the registered domain as the location information domain server 120, includes a web page with which a user connects in order to make his position ID and register it, software required for confirming duplication of user's position ID and inputting user information into the location information database, a web page and software for managing user's location information, a web page and software for searching for a location information, maps and geographical information databases for identifying and indicating the physical location coordinates and GIS software for searching and displaying a location on the map. Here, the maps and geographical information databases can be used for identifying the location coordinate for a user when the user registers his location information.

At a location information domain server installation step S37, the program downloaded at the step S36 is installed in the location information domain server 120. By doing so, the configuration of the location information domain server for registering and searching for the user's location information, which will be described below, is accomplished.

After registration of the location information domain server 120, the user who wants to register his location information (coordinate) at the corresponding domain server 120 connects with that server 120. This step is the location information domain server connection step S40 where the user directly connects with the location information domain server 120 or connects with the location information domain server 20 via the general domain server 150 linked to the location information domain server. Furthermore, a user who wants to search for location information can also connect with the location information domain server 120 to search for some location information.

In other words, if a user wants to connect with the general domain server 150 to register his location information (coordinate) thereat, the general domain server 150, when it is linked with the location information domain server 120, stores the information in the location information domain database of the linked location information domain server 120 and manages it. Otherwise, the user can directly connect with the location information domain server 120 to register his location information thereat. It is obvious to those skilled in the art that the two aforementioned configurations are available.

Thereafter, it is confirmed if the user's location information (coordinate) has been registered at a step S50. When the same user's location information has not been registered previously, the process goes to a user's location information registration step S60 where the user's location information is registered. When the same user's location information has been already registered previously, the process moves to a step S70 where the user performs a required work without doing the step S60.

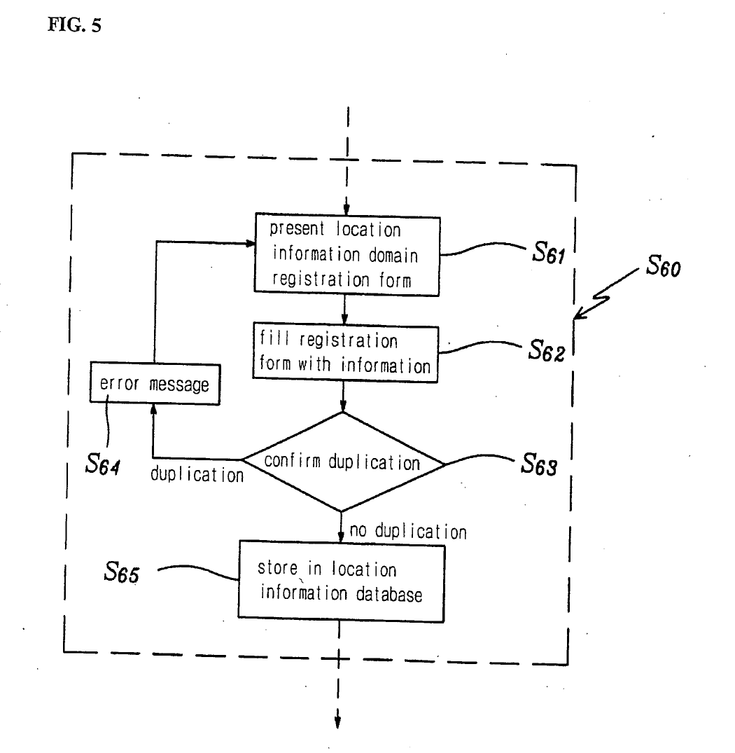

The user's location information registration step S60 is shown in FIG. 5 in more detail. This user's location information registration step is similar to the location information domain registration step S30.

Referring to FIG. 5, when it is confirmed that the user's location information has not been registered previously at the location information registration confirming step S50, the location information domain server 120 presents a registration form (not shown) at a registration form presenting step S61. Though the registration form may be similar to the one shown in FIG. 4, it can have a different configuration according to the managing scheme by the manager of each location information domain server. However, the registration form must be constructed in such a manner that the mandatory items such as user's address, accurate location coordinate and position ID should be included.

At a form input step S62, the required information is entered into the registration form presented at the step S61. At this time, the user's position ID is entered in the form of “[user ID]#[location information domain address]”. Here, the user ID is an arbitrary character string, and the location information domain address corresponds to the location information domain server 120 and is entered in the same form as the domain address of the existing web server. The symbol for identifying the position ID is not limited to #, as described above. The location information includes maps and geographical information. That is, the location coordinate can be entered in a manner that a location is designated with a mouse on a map displayed using maps and geographical databases.

At a duplication confirmation step S63, it is confirmed if the user's location address among the contents entered at the form input step S62 is a duplicate one. If it is, the process goes to an error message indicating step S64 to show an error code to the user who wants to register his location information, and then presents the registration form again. When the user's position ID is confirmed not to be a duplicate one at the duplication confirmation step S63, the process goes to a location information storing step S65 where the information entered by the user into the registration form is stored together with the position ID in the location information domain database of the location information domain server 120 to be managed by the server 120.

After the user has registered his location information at the location information domain server 120, as described above the user can connect with any of location information domain servers 120a to 120n or the general domain server 150 having program related with the location information domain management server 110 installed therein to perform a desired operation, for example, buying goods or requesting necessary information or data. This step corresponds to the desired operation executing step S70 in FIG. 2. That is, the user carries out an operation such as purchasing goods at a web server (a general domain server or a web server linked with the location information domain server) with which he connects in this step.

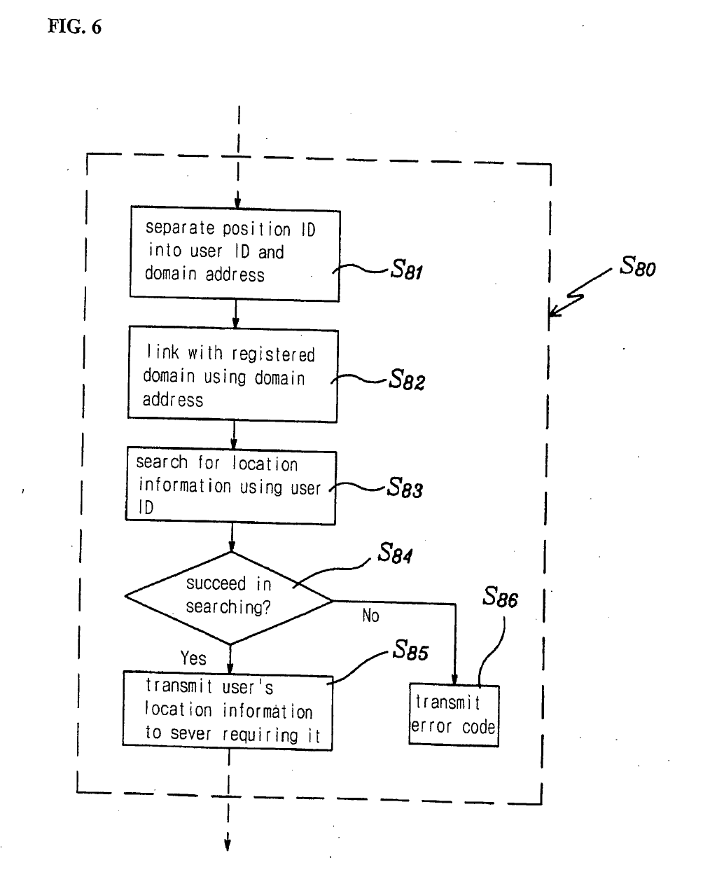

Upon completion of the desired operation executing step S70, the web server with which the user connects must identify the location information of the user in order to send the information or goods the user wants to obtain to the user. For this, the web server is provided with the registered position ID, connects with the location information domain server 120 at which the user's location information has been registered and then searches for the user's location information (coordinate) using the position ID of the user. This step is the user's location information searching step S80 shown in FIG. 2. FIG. 6 shows the user's location information searching step in more detail.

Referring to FIG. 6, when the user finished a desired work at the step S70, the process goes to a step S81 where the domain address of the location information domain server 120 registered by the user is separated from the position ID constructed of the user ID and the domain address. Then, an attempt to link with the registered location information domain server 120 is made using the separated domain address at a step S82.

Upon connection with the location information domain server 120, the user's location information (coordinate) is searched for using the user ID. This step is the user's location information searching step S83. When the searching step S83 has been finished, it is confirmed if the searching was normally performed at a step S84. If it was, the process goes to a location information transmitting step S85 where the user's location information is sent to the web server that requests for it. If it was not, the process moves to an error code transmitting step S86 to report the cause of the failure in the searching to the server that request for the user's location information.

Through the aforementioned steps, the web server 120 or 150 with which the user connects sends the confirmed user's location information together with the one the user wants (here, goods the user wants to purchase) to a delivery company or distribution center to allow it to deliver the goods to the user. In case where an error is generated at the searching step S80, however, searching is carried out again or an error message is sent to the user to allow the user to take an appropriate management.

### INDUSTRIAL APPLICABILITY

As described above, according to the method for registering and searching for a user's location coordinate using distributed location information domain servers and the system used for the method, the user can provide his location information without signing in web servers and inputting his location information whenever he connects with the web servers, resulting in convenient and rapid processing in transactions on the Internet.

Furthermore, web servers registered as the location information domain servers can share user's location information registered at each web server and, if required, even a web server that is not registered as the location information domain server can search for the user's location information only by installing necessary program therein. Thus, information can be managed more efficiently. Moreover, the present invention does not employ the conventional address information but provides location information using the position ID registered instead of the actual location coordinate so that the accurate location of the user can be found more conveniently.

In addition, since the location information domain management server manages the location information domain servers, the user's location information can be managed in the same form, excluding duplicated registration of the location information. Furthermore, since it is sufficient that the user register his location information at only one domain server he wants, duplicated registration of data can be avoided and the location information can be prevented from being concentrated on a certain server, to result in smooth processing of information.

Although specific embodiments including the preferred embodiment have been illustrated and described, it will be obvious to those skilled in the art that various modifications may be made without departing from the spirit and scope of the present invention, which is intended to be limited solely by the appended claims.

What is claimed is:

1. A system for registering and searching for user's location information stored at the distributed location information domain servers using user's position ID, comprising:
a location information domain management server 110 having a location information domain management database, the location information domain management server managing a plurality of location information domain servers 120a to 120n, the location information domain management server carrying out an operation of registering, updating, modifying or deleting a location information domain and storing information related with the operation in the location information domain management database;
the plurality of location information domain servers 120a to 120n each of which has a location information domain database registering user's location information together with a position ID to store them in the location information domain databases and manage (update, modify or delete) them, each location information domain server searching for user's location information (coordinate) requested by another web server to transmit it to the web server or requesting another location information domain server to search for the user's location information (coordinate);
a location information domain manager terminal 130 for managing the location information domain management server;
user terminals 140a to 140n by which users connect with desired web servers through the Internet 160;
general domain servers 150a to 150n each of which is not registered at the location information domain management server 110 as one of the location information domain servers, each general domain server having software required for searching for the user's location information installed therein, each general domain server having no functions of storing and managing the user's location information; and
the Internet 160,
wherein the user's location information is registered together with the position ID at the information location domain servers and the registered user's location information is confirmed.

2. The system as claimed in claim 1, wherein the functions of the location information domain servers 120a to 120n and the functions of web servers linked with the location information domain servers can be constructed in the one system or in the separate different system.

3. The system as claimed in claim 1, wherein the plurality of location information domain servers 120a to 120n manage user's location information and are independently operated by each web domain, and a new web page for a location information domain can be added to the existing web server for providing the function of the location information domain server.

4. The system as claimed in claim 1, wherein the location information domain manager terminal 130 may be connected with the location information domain management server 110 via a LAN instead of the Internet 160.

5. A method for registering and searching for user's location information stored at the distributed location information domain servers using user's position IDs, the method comprising:
a location information domain management server connection step S10 in which a user who wants to register at a location information domain server 120 or to search for location information connects with a location information domain management server 110;
a location information domain registration confirming step S20 for confirming if the same location information domain that user wants to register has been already registered;
a location information domain registration step S30 for registering the location information domain when it is confirmed that the same location information domain which user wants to register has not been registered yet;
a step S40 in which the user registered at the location information domain server 120 or the user who wants to search for location information can connect with the location information domain server 120;
a step S50 for confirming if location information (coordinate) including a user's position ID has been registered;
a user location information registration step S60 for registering the user's location information when the same user's location information has not been registered at the location information domain server 120;
a step S70 in which the user carries out an operation he wants at a web server with which the user connects through the Internet 160; and
a step S80 for searching for the user's location information after connecting with the location information domain server 120 at which the user's location information has been registered, according to the result of the operation carried out by the user at the step S70.

6. A method as claimed in claim 5, wherein the location information domain server connection step S30 comprises:
a step S31 for presenting a registration form 170 for registering a connected web server as a location information domain;
a step S32 for inputting information required for registration of the location information domain;
a duplication confirmation step S33 for confirming if the location information domain name among the entered information is a unique character string;
a step S34 for indicating an error message and presenting the registration form again when the domain name of the location information domain server 120 is to be a duplicate one during the duplication confirmation step S33;
a step S35 for registering the location information domain server 120 at a location information domain management database and recording the information entered at the step S32, when the entered location information domain name to be registered is not a duplicate one;
a step S36 for downloading program required for operating the location information domain server 120 from the location information domain management server 110; and
a step S37 for installing the program downloaded at the step S36 in the location information domain server 120.

7. The method as claimed in claim 5, wherein the user location information registration step S60 comprises:
a registration form presenting step S61 for registering the user's location information when it has not been registered previously;
a data input step S62 for inputting information required into the registration form;
a duplication confirmation step S63 for confirming if a user's position ID among the contents entered at the step S62 is a duplicate one;
a step S64 for indicating an error message and going to the registration form presenting step S61 when the user's position ID is a duplicate one; and
a step S65 for storing location information including the user's position ID and the point location coordinate into the location information domain database of the location information domain server 120 to manage it.

8. The method as claimed in claim 5, wherein the user location information searching step S80 comprises:
a step S81 for separating a user ID and a domain address constructing the user's position ID from each other;
a step S82 for connecting with the location information domain server 120, using the separated domain address, at which the user registered the location information;
a step S83 for searching for the user's location information using the separated user ID;
a step S84 for confirming if the searching step S83 has been normally carried out;
a step S85 for transmitting the searched location information to the requesting server for searching for the location information, when it is confirmed that the searching operation has been normally carried out; and
a step S86 for transmitting an error code (indicating the reason of the failure during searching operation) when it is confirmed that the searching operation has not been normally carried out.

9. The method as claimed in claim 7, wherein the user's position ID among the information entered into the form at the form input step S62 is a unique identification address for the registered point location and is indicated in the form of [user ID]#[location information domain server].

10. The method as claimed in claim 7, wherein, in the form input step S62, the user inputs a location coordinate value in such a manner that he designates the point location to be registered on a map displayed on a display screen using a map and geographical information database in order to register his location information (coordinate).
